(19) United States
(12) Patent Application Publication
(10) Pub. No.: US 2026/0362091 A1
(43) Pub. Date: Nov. 12, 2026

(54) Method for Transferring a Call

(71) Applicant: Bayerische Motoren Werke Aktiengesellschaft, Muenchen (DE)

(72) Inventor: Michael NEUHAEUSER, Sankt Wolfgang (DE)

(21) Appl. No.: 19/134,445

(22) PCT Filed: Oct. 12, 2023
(86) PCT No.: PCT/DE2023/100761

§ 371 Date: May 30, 2025

(30) Foreign Application Priority Data
Dec. 9, 2022 (DE) 10 2022 132 827.9

(51) Int. Cl. H04W 4/16; H04M 1/72403; H04M 3/46; H04M 3/54

(52) U.S. Cl. CPC H04W 4/16; H04M 1/72403; H04M 3/465; H04M 3/54; H04M 2201/42

(57) ABSTRACT

A method for transferring a call includes receiving, via an application, instructions to transfer a call from a first communication module to a second communication module. A trigger with respect to the transfer of the call is transmitted, via the application, to a mobile radio network operator to which the first communication module and the second communication module are assigned. Instructions are transmitted, via the mobile radio network operator, to the second communication module to output an incoming call display or a signal. The call is transferred, via the mobile radio network operator, from the first communication module to the second communication module based on a user input with respect to the incoming call display or signal.

### BACKGROUND AND SUMMARY

The present invention relates to a method for transferring a call, a data storage medium containing an application for executing the method, a mobile device containing the storage medium, and a communication system. The present invention relates in particular to transferring a call between two communication modules that have the same telephone number.

Communication networks for modern vehicles are becoming increasingly important. By way of example, a user can make telephone calls and make use of cloud services with a communication module built into a vehicle. The communication module in the vehicle can contain a SIM card, for example, with which such connectivity can be obtained through a mobile network such as LTE or 5G.

Moreover, users frequently have numerous mobile end devices such as smartphones and tablets. When the user exits the vehicle during a call, the call can be transferred to another device. This may be difficult, however, during a call connected to the communication module in the vehicle, and not to the mobile end device. This may be inconvenient for the user.

The object of the present invention is to create a method for transferring a call, a data storage medium containing an application for executing the method, a mobile device containing a storage medium, and a communication system with which calls can be efficiently transferred between two communication modules. Another object of the present invention is to improve user-friendliness when transferring calls between communication modules.

These problems are addressed by the subject matter disclosed herein.

One aspect of the present invention relates to a method for transferring calls. The method comprises receiving instructions from an application to transfer a call from a first communication module to a second, both of which can have the same, or different, telephone numbers, sending a trigger regarding the transfer by the application to a mobile network provider for the first and second communication module, sending instructions by the mobile network provider to the second communication module to output an incoming call signal, and transferring the call by the mobile network provider from the first communication module to the second based on user input in response to the incoming call signal.

If the user exits the vehicle, for example, while telephoning with an eSIM in the vehicle, the user may want to transfer the call to a cell phone, or some other device with the same telephone number (or a previously configured device with a different telephone number). A dedicated trigger is used with the invention for transferring the call from the vehicle to the cell phone, such that all of the user's devices with the same telephone number are signaled. If the user accepts the call on the cell phone, the call is transferred from the vehicle to the cell phone.

The trigger is generated by the application in the invention. In other words, the trigger is not a modem trigger such as an SIP invitation. In particular, the transfer is not triggered by the communication module in the mobile device, or its modem, that is transferring the call. This results in a flexible, simple and inexpensive call transferring, independently of any concrete communication module modem architecture in the mobile device transferring the call.

The first and second communication modules preferably have the same telephone number. In a second embodiment, the second communication module can have a different telephone number. The term, “telephone number,” is a series of numbers for making a telephone call.

The term, “application,” relates to application software or a program in the framework of the present invention. In particular, an application is a computer program that provides the trigger function on its own.

The first and/or second communication modules are preferably configured to communicate wirelessly with a mobile network. The first and/or second communication modules can be configured to communicate using LTE (long term evolution) and/or 5G. Other available or future communication technologies may also be used. The present invention is not limited to specific wireless technologies, and non-wireless technologies could also be used.

The term, “mobile network provider,” relates to a network provider for a mobile network (mobile network operator (MNO)) in the framework of the present invention. The mobile network provider can enable communication in a mobile network using LTE (long term evolution) and/or 5G.

The first communication module preferably has a first communication profile for the user. The first communication profile can be a first SIM or eSIM profile for the user.

The second communication module can have a second communication profile for the user. The second communication profile can be a second SIM or eSIM profile.

SIM, or eSIM (embedded Subscriber Identity Module) is a standardized method for safely embedding user information in a communication module in a telecommunication device. Protection and data confidentiality are important aspects of communication using the eSIM. The communication module in question contains a standardized digital certificate for this. There are a variety of different certificates throughout the world, and a specific type of eSIM will only function with a specific type of certificate.

The present invention is not limited to SIM or eSIM profiles, and the first and/or second communication profiles can use other IDs that can be configured by the user. One example of such is the Microsoft Team ID.

The first communication module is preferably contained or integrated in a first mobile device. The second communication module can also be contained or integrated in a second mobile device.

The first and/or second mobile devices are preferably part of, or contained in a mobile end device and a means of transportation.

The first mobile device is preferably a means of transportation such as a vehicle, and the second mobile device is preferably a mobile end device. Alternatively, the second mobile device can be the transportation means, while the first is then a mobile end device.

A mobile end device is a device that can communicate wirelessly within a mobile network through a local area network (LAN), e.g. wireless LAN (Wi-Fi/WLAN) or Wide Area Network (WAN), e.g. Global System for Mobile Communication (GSM), General Package Radio Service (GPRS), Enhanced Data Rates for Global Evolution (EDGE), Universal Mobile Telecommunications System (UMTS), High Speed Downlink/Uplink Packet Access (HSDP, HSUPA), Long-Term Evolution (LTE), 5G, or World Wide Interoperability for Microwave Access (WIMAX).

The term, “mobile end device,” relates in particular to smartphones as well as other mobile telephones or cell phones, personal digital assistants (PDAs), tablets, notebooks, smart watches, smart glasses, and any available or future electronic devices containing communication technology.

The transportation means is preferably a vehicle, in particular a motor vehicle. The transportation means can be a vehicle (e.g. motor vehicle), boat, or aircraft (e.g. a passenger drone), but is not limited thereto. A vehicle can be a passenger automobile, truck, bus, mobile home, motorcycle, etc. with which people, goods, etc. can be transported. In particular, a motor vehicle is used to transport people.

Receiving instructions to transfer a call from a first communication module to a second preferably comprises receiving a manual user input to transfer the call, in particular to the first or second mobile device. In other words, the user can actively initiate or request the call be transferred to a second communication module.

The user can input the instruction to the first mobile device (e.g. a vehicle) or second mobile device (e.g. a cell phone). A user interface in the first or second mobile device can be used for this.

In some embodiments, the first or second mobile device may indicate to the user through the user interface that it is possible to transfer a call, and offer the user corresponding options. This may be triggered by the user, e.g. by shutting off a motor, and/or upon reaching a destination, and/or opening a vehicle door, during the call.

The user interface can have at least one output device and one input device. The user interface can be a central information output and input device for an infotainment system in a vehicle, e.g. an automotive head unit or a pillar to pillar display. The user interface is preferably permanently installed in the vehicle.

The at least one output device can contain at least one display and/or at least one speaker. The at least one display can be an LCD, plasma display, or OLED display. The display can also contain a projector configured to project information directly into the user's field of vision, in particular on a windshield.

The at least one input device can be a touchscreen or touch pad, and/or a tactile input device such as a switch (e.g. a button or dial), or some other type of mechanical keyboard.

The user interface preferably in the first mobile device (e.g. the vehicle) or second mobile device (e.g. the cell phone) preferably contains, or is, a touchscreen forming at least one output device and at least one input device.

Receiving instructions to transfer a call from a first communication module to a second preferably involves receiving automated instructions to transfer the call, in particular by the first or second mobile device. By way of example, the application can receive a transfer trigger from the first or second mobile device that represents the automated instruction. The transfer trigger can be shutting off the motor, and/or reaching a destination, and/or opening a vehicle door.

The application is preferably for the first communication module. In particular, the application can be integrated or implemented in the first communication module and/or first mobile device. The application can also be for the second communication module. In particular, the application can be integrated or implemented in the second communication module and/or second mobile device.

The trigger preferably contains code, or is code. The code is configured to transfer a call from a first communication module to a second communication module through the mobile network provider. The code can be specific to and/or provided by the mobile network provider.

In some embodiments, the code can be a sequence of keystrokes. The sequence can contain numbers from 0 to 9, and/or special characters such as * (star key) or # (pound key). In an exemplary embodiment, the code can be a sequence of keystrokes for forwarding a call.

The user can manually input the code, or character sequence, in some embodiments. In other embodiments, the user can press a button, for example, which then inputs the code or character sequence. This manual input can be the previously explained reception of a manual user input to transfer the call.

The incoming call display preferably comprises an acoustic, optical, and/or tactile signal. The acoustic signal can be a ringtone, for example. The optical signal can be on a display, indicating the incoming call. The tactile signal can be a vibration.

The mobile network provider preferably sends the instruction to output an incoming call signal to at least one other communication module that has the same telephone number as the first and second communication modules. This other communication module could also have another telephone number than the first and/or second communication modules.

In some embodiments, the other communication module can be integrated in another of the user's mobile devices. By way of example, the first communication module can be integrated in a user's vehicle, the second in a mobile telephone, and the third in a tablet.

The mobile network provider can preferably send the instruction to output an incoming call signal to some, in particular all, communication modules that have the same telephone number as the first and second communication modules. By way of example, all of the user's devices that have that telephone number can ring, allowing the user to choose which device the call is to be transferred to.

The mobile network provider could also send the instruction to output an incoming call signal to communication modules selected by the user, e.g. that have the same telephone number as the first and second communication module. By way of example, the user can determine in advance which devices are to be signaled when transferring a call.

Another aspect of the present invention relates to a software (SW) program. The SW program can be configured to be executed on one or more processors to carry out the method for transferring calls described herein.

Another aspect of the present invention relates to a data storage medium. The storage medium can contain an SW program configured to be executed on one or more processors to carry out the method for transferring calls described herein.

Another aspect of the present invention relates software containing programming code. The software is configured to carry out the method for transferring calls, when executed on one or more devices controlled by software.

Another aspect of the invention relates to a data storage medium for transferring calls. The storage medium contains an application configured to execute the following on one or more processors: receive instructions to transfer a call from a first communication module to a second communication module, in which the first and second communication modules have the same or different telephone numbers, send a trigger regarding transferring the call to a mobile network provider for the first and second communication modules, which is configured to cause the mobile network provider to send instructions to the second communication module to output an incoming call signal, such that the call can be transferred from the first communication module to the second, based on user input in response to the incoming call signal.

Another aspect of the present invention relates to a mobile device. The mobile device contains the data storage medium described in this application for transferring calls.

The mobile device is preferably a mobile end device or transportation means.

Another aspect of the present invention relates to a communication system. The communication system contains processors, data storage media connected to the processors and containing instructions that can be carried out by the processors to execute the method for transferring calls described herein.

The communication system is configured in particular to execute the method for transferring calls described in this application. The method for transferring calls can make use of the communication system described in this application.

A processor or processor module is a programmable computer, i.e. a machine or electronic circuit that controls other elements according to commands it receives, and executes an algorithm (process).

Another aspect of the present invention relates to a vehicle, in particular a motor vehicle. The vehicle contains (or is) the mobile device and/or contains at least part of the communication system obtained with the present invention.

The term, “vehicle,” refers to passenger automobiles, trucks, busses, mobile homes, motorcycles, etc. with which people, goods, etc. can be transported. In particular, the term, “passenger automobile,” refers to people movers.

Exemplary embodiments of the invention are illustrated in the drawings and shall be explained in greater detail below.

### BRIEF DESCRIPTION OF THE DRAWINGS

FIG. 1 shows a flow chart for a method for transferring calls in accordance with an embodiment of the present invention, and

FIG. 2 shows a schematic illustration of how a call is transferred from a vehicle to a cell phone in accordance with an embodiment of the present invention.

### DETAILED DESCRIPTION OF THE DRAWINGS

The same reference symbols are used in the following for identical elements, and elements with the same function, unless otherwise indicated.

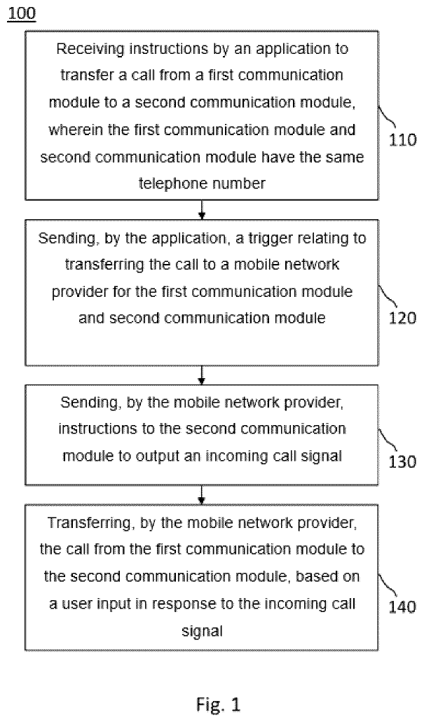

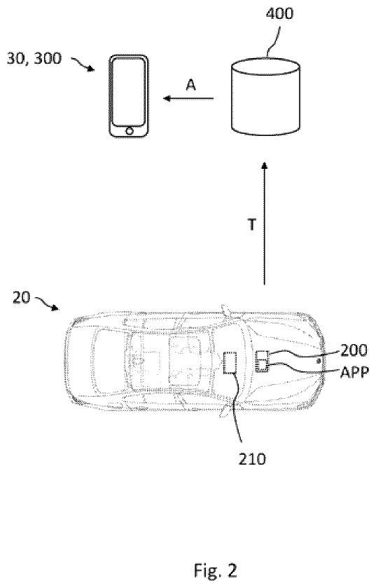

FIG. 1 shows a flow chart for a method 100 for transferring calls in accordance with an embodiment of the present invention. FIG. 2 schematically illustrates a transportation means 20 and a mobile end device 30 according to embodiments of the present invention. In some embodiments, the transportation means 20 is a vehicle, in particular a motor vehicle.

The method 100 can be implemented by corresponding software that can be executed by one or more processors (e.g. a CPU).

The method 100 contains a receiving step 110 in which an application APP receives instructions to transfer a call from a first communication module 200 to a second communication module 300, with the first communication module 200 and second communication module 300 having the same telephone number (alternatively, the first communication module 200 and second communication module 300 can have different telephone numbers); a sending step 120, in which a trigger T for transferring the call is sent by the application APP to a mobile network provider 400 for the first communication module 200 and second communication module 300; a transmitting step 130, in which instructions A are sent by the mobile network provider 400 to the second communication module 300 to output an incoming call signal; and a transferring step 140, in which the call is transferred from the first communication module 200 to the second communication module 300 by the mobile network provider 400, based on user input in response to the incoming call signal.

The first communication module 200 is in the vehicle 20 in FIG. 2, and the second communication module 300 is in the mobile end device 30. The present invention is not limited to this, however, and the first communication module 200 and second communication module could be in other devices, in particular user's mobile devices.

The first communication module 200 and/or second communication module 300 can be configured to communicate wirelessly in a mobile network. The first communication module 200 and/or second communication module 300 can be configured to communicate using LTE (long-term evolution) and/or 5G.

The first communication module 200 has a first communication profile in some embodiments, e.g. a first eSIM profile, and the second communication module 300 has a second communication profile, e.g. a second eSIM profile. The first communication profile and/or second communication profile can be provided by the mobile network provider 400 (mobile network operator (MNO)).

The first communication module 200, or first communication profile, and second communication module 300, or second communication profile, can have the same telephone number. Alternatively, the first communication module 200, or first communication profile, and second communication module 300, or second communication profile, can have different telephone numbers. The term, “telephone number,” refers to a sequence of numbers for calling a telephone.

In some embodiments, receiving instructions to transfer a call from the first communication module 200 to the second communication module 300 involves receiving user input. This can take place in the vehicle 20 or the mobile end device 30.

By way of example, the vehicle 20 contains an input unit 210, e.g. a touchscreen in an infotainment system. In another example, the input unit 210 can be configured for voice input. The present invention is not limited to this, and the input unit 210 can be a touch-sensitive and/or mechanical keypad, or switches. The input unit 210 can be on a center console in the vehicle 20, for example.

In another example, the mobile end device 30 contains the input unit. The input unit is preferably a touchscreen on the mobile end device 30.

Alternatively, the instruction to transfer the call can be generated automatically. By way of example, the application APP can receive a transfer trigger that automatically displays the instructions. The transfer trigger can be shutting off the motor, reaching a destination, and/or opening a vehicle door, for example.

The application APP sends the trigger T to the mobile network provider 400. In some embodiments, the trigger T can comprise a sequence of keystrokes. The keystrokes can be composed of numbers from 0 to 9 and/or special characters, e.g. * (star) or # (pound sign). In an exemplary embodiment, the code can be a sequence of keystrokes for forwarding a call.

When the trigger T has been received, the mobile network provider 400 sends the instruction A to output an incoming call signal to the second communication module 300, e.g. a ringtone. If the user accepts the call on a cell phone 30, the call is transferred from the first communication module 200 to the second communication module 300, such that the user can continue the call without interruption.

A dedicated trigger is used in the invention to transfer the call from the vehicle to the cell phone, signaling all of the user's devices with the same telephone number. If the user accepts the call on the cell phone, the call is transferred from the vehicle to the cell phone. The trigger for this is generated by an application. In other words, the trigger is not a modem trigger, e.g. an SIP invitation. In particular, transferring is not triggered by the communication module in the transferring mobile device, or its modem. This results in a flexible, simple, and inexpensive transferring, independently of the communication module modem architecture in the transferring mobile device.

Although the invention is illustrated and explained in detail using preferred exemplary embodiments, it is not limited to the disclosed examples, and other variations can be derived therefrom by the person skilled in the art, without abandoning the scope of protection for the invention. It is therefore clear that there are a number of possible variations. It is also clear that exemplary embodiments are only examples that in no way limit the scope of protection, the possible applications, or the configuration of the invention. Instead, the above descriptions and the drawings provide the person skilled in the art with a means of obtaining concrete embodiments from examples in which the person skilled in the art can make numerous modifications based on the concept of the disclosed invention with regard to the functioning or configuration of individual elements in an exemplary embodiment, without abandoning the scope of protection defined by the claims and legal equivalents, such as any further explanations in the description.

1-10. (canceled)

11. A method for transferring calls, comprising:
receiving, by an application, instructions to transfer a call from a first communication module to a second communication module, wherein the first communication module and second communication module have the same telephone number or different telephone numbers;
sending, by the application, a trigger relating to transferring the call to a mobile network provider for the first communication module and second communication module;
sending, by the mobile network provider, instructions to the second communication module to output an incoming call signal; and
transferring, by the mobile network provider, the call from the first communication module to the second communication module, based on user input in response to the incoming call signal.

12. The method of claim 11, wherein the first communication module contains a first communication profile for the user and the second communication module contains a second communication profile for the user.

13. The method of claim 11, wherein the first communication module is contained in a first mobile device and the second communication module is contained in a second mobile device.

14. The method of claim 13, wherein receiving the instructions to transfer the call from the first communication module to the second communication module comprises:
receiving a manual user input to transfer the call on the first mobile device or the second mobile device, or
receiving automated instructions to transfer the call by the first mobile device or the second mobile device.

15. The method of claim 13, wherein:
the application is integrated in the first communication module and/or the first mobile device, or
the application is integrated in the second communication module and/or the second mobile device.

16. The method of claim 11, wherein the trigger comprises a sequence of keystrokes.

17. The method of claim 11, wherein:
the incoming call signal is an acoustic, optical, and/or tactile signal, and/or
the mobile network provider sends the instructions to output the incoming call signal to: all communication modules with the same telephone number as the first communication module and second communication module, or communication modules previously selected by the user.

18. A non-transitory storage medium storing instruction that when executed by a processor causes the processor to carry out a method for transferring calls, comprising:
receiving instructions to transfer the call from a first communication module to a second communication module, wherein the first communication module and second communication module have the same telephone number or different telephone numbers; and
sending a trigger regarding transferring the call to a mobile network provider for the first communication module and second communication module, wherein the trigger is configured to cause the mobile network provider to send instructions to the second communication module to output an incoming call signal such that the call can be transferred from the first communication module to the second communication module based on a user input in response to the incoming call signal.

19. A communication system, comprising:
one or more mobile devices, each having a processor and a non-transitory storage media storing instructions that when executed by a processor causes the processor to:
receive instructions to transfer the call from a first communication module to a second communication module, wherein the first communication module and second communication module have the same telephone number or different telephone numbers; and
send a trigger regarding transferring the call to a mobile network provider for the first communication module and second communication module, wherein the trigger is configured to cause the mobile network provider to send instructions to the second communication module to output an incoming call signal such that the call can be transferred from the first communication module to the second communication module based on a user input in response to the incoming call signal.
